(19) United States
(12) Patent Application Publication
(10) Pub. No.: US 2019/0042232 A1
(43) Pub. Date: Feb. 7, 2019

(54) TECHNOLOGIES FOR AUTOMATIC COMPILATION OF STORAGE OFFLOADS

(71) Applicant: Intel Corporation, Santa Clara, CA (US)

(72) Inventor: Sanjeev Trika, Portland, OR (US)

(21) Appl. No.: 16/145,701

(22) Filed: Sep. 28, 2018

(51) Int. Cl. G06F 8/75; G06F 8/41; G06F 9/50

(52) U.S. Cl. CPC G06F 8/75; G06F 2209/509; G06F 9/5055; G06F 8/41

(57) ABSTRACT

Technologies for automatic compilation of storage offloads include a compute device. The compute device further includes a compiler logic unit to analyze a source code of an application, identify a section of the source code that includes operations to be offloaded to a data storage device on a target compute device, extract, in response to an identification of the section that includes operations to be offloaded, the section of the source code, and compile the section of the source code extracted as an offload function.

### BACKGROUND

During execution of an application on a compute device, the compute device may offload some operations to a heterogeneous device (e.g., a device having a different architecture than the general purpose processor of the compute device) to accelerate execution of the application. However, each offload requires careful programming and debugging by developers of both a kernel and its host program with considerations of parallelism and synchronization of command and data flow across the heterogeneous devices.

Open Computing Language (OpenCL) is a parallel computing platform that may be used to write codes that are executed across heterogeneous platforms to deploy offload kernels. In OpenCL, parallel compute kernels may be offloaded from a host compute device to a heterogeneous device such as a central processing unit (CPU), a graphic processing unit (GPU), Field-Programmable Gate Array (FPGA), or other processor or accelerator of the host compute device that is OpenCL-capable or compatible. However, because some devices may be OpenCL-incapable or incompatible, core operations of an application are generally programmed twice—once for systems that support OpenCL and once for systems that do not support OpenCL. Programming of OpenCL kernels is also error-prone and takes significant effort to optimize.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of an offload system that includes a compiler compute device, one or more compute devices, one or more data storage devices, and one or more offload controllers;

FIG. 2 is a simplified block diagram of at least one embodiment of the data storage device of FIG. 1; and

FIG. 3 is a simplified flow diagram of at least one embodiment of a method for automatic compilation of an application section as offload functions that are to be executed on a target data storage device that may be executed by the compiler compute device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

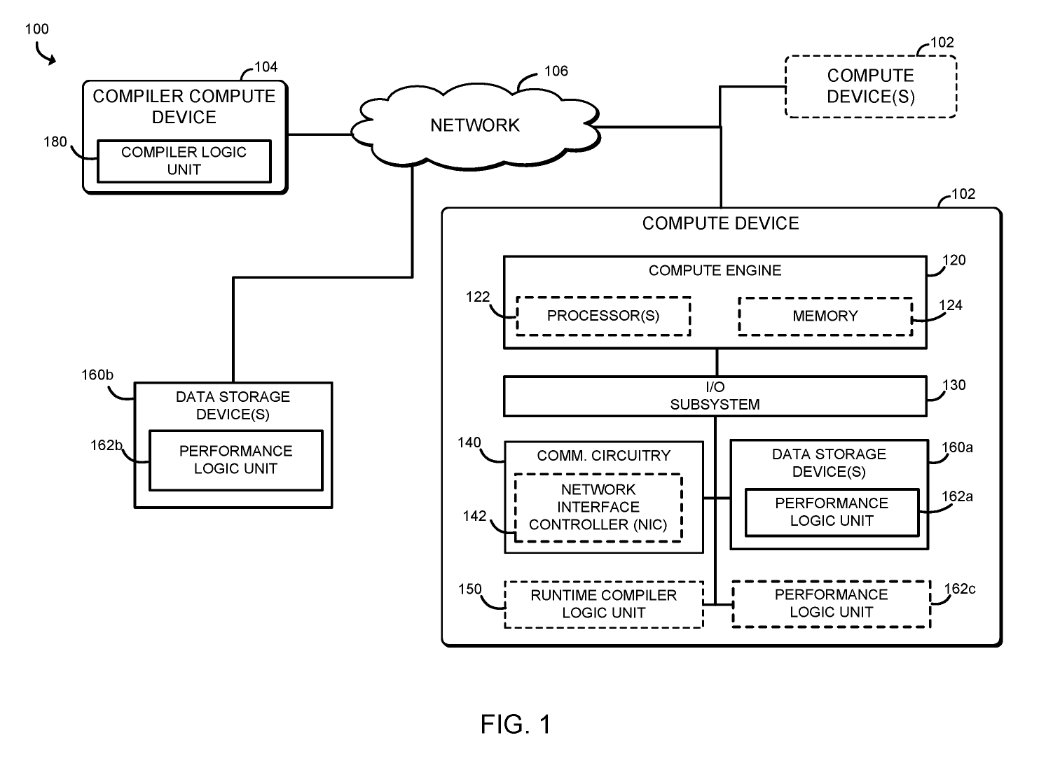

Referring now to FIG. 1, an illustrative an offload system 100 for offload operation on a data storage device includes a compiler compute device 104 and one or more compute devices 102. Each compute device 102 further includes one or more data storage devices 160. In the illustrative embodiments, the offload system 100 further includes one or more data storage devices 160 that are communicatively coupled to the compute device 102 via a network 106.

In use, the compiler compute device 104 may compile a source code of an application. To do so, the compiler compute device 104 includes a compiler logic unit 180 that may automatically detect within the application a different section of the source code that is preferably to be executed on a target data storage device 160a or 160b. In the illustrative embodiment, a developer of the source code may specify hints (e.g., start and stop of the offload operation) in the source code without changing source code logic indicating which section of the source code is desirable to be offloaded to the target data storage devices 160 as an offload kernel. It should be appreciated that, in some embodiments, the source code may be in a heterogeneous-programming language, such as Open Computing Language (OpenCL), CUDA, x86-assembly, or arm-assembly.

For example, the compiler compute device 104 may detect within an application source code various sections of offload logic that may be compute-light and data-intensive for encapsulation as OpenCL kernels to be executed on heterogeneous devices. It should be appreciated that a section of the source code that is data-intensive but compute-light may be a good candidate to be offloaded to the target data storage devices 160 because it obviates a need for a large amount of data to be transferred back and forth between a processor of the host compute device 102 and the corresponding data storage device 160 to do a small amount of work on each data element. This allows the data to be processed inside the data storage device 160 without having to transfer the data to a memory 124 of the compute device 102. These offload sections may include those that are automatically detected and those that are marked by a developer of the source code as a candidate for compiling as an offload kernel. Other sections of the source code may be marked as non-offloads, and may be compiled without converting those sections to offloads. It should be appreciated that by determining and compiling one or more sections of the source code to be an offload kernel for execution on the data storage devices 160, the compiler compute device 104 may decrease errors and increase run-time efficiencies, when the application is executed on the compute device 102.

At compile time, the compiler logic unit 180 may include, for each identified offload-section in a compiled application or program, logic that can run natively on the processor 122 of the compute device 102 and kernel logic that can run on the storage devices 160. In the illustrative embodiment, the compiler logic unit 180 may also include logic to instruct the processors 122 of the compute device 102 to detect whether the storage devices 160 are capable of running an offload kernel in a heterogeneous-programming language, such as an OpenCL kernel, to determine whether the kernel logic may be executed on the data storage devices 160. Open Computing Language (OpenCL) is a parallel computing platform that may be used to write codes that are executed across heterogeneous platforms and to deploy an offload kernel to the data storage devices 160. In that example, the compute device 102 may determine whether a target data storage device 160 is OpenCL-capable or compatible.

It should be appreciated that the section of the source code may include some functions that OpenCL may not understand. In such a case, the compiler compute device 104 will ignore the annotation of that section and will not convert the section to an offload kernel. If the target data storage device 160 is OpenCL-capable or compatible, a section of the source code that includes offload operations may be offloaded at run-time to the target data storage device 160 and executed inside the target data storage device 160 to perform offload operations. It should be appreciated that this may obviate a need for developers to program core operations of an application twice, which may lower development-time costs for the application.

Additionally, each data storage device 160 includes a corresponding performance logic unit 162a, which may be embodied as software or circuitry (e.g., a co-processor, a microcontroller, an application specific integrated circuit (ASIC), a field programmable gate array (FPGA), etc.) configured to extend an API for coordinating parallel computation to execute one or more offload kernels to compile a section of the source code that is offloaded to the data storage device 160 to perform offload operation(s) inside the data storage device 160. It should be appreciated that, in some embodiments, the corresponding performance logic unit 162 may reside outside of the data storage devices 160. It should also be appreciated that the data storage device 160 may be embodied as any storage device, volume, namespace, or appliance, such as a solid-state drive (SSD), a hard disk drive (HDD), erasure-coded volumes, storage-rack-appliances, storage-namespaces, and storage partitions.

As discussed above, the compiler compute device 104 includes the compiler logic unit 180, which may be embodied as software or circuitry (e.g., a co-processor, a microcontroller, an application specific integrated circuit (ASIC), a field programmable gate array (FPGA), etc.) configured to automatically identify one or more sections of the source code of the application that is capable of running on data storage devices 160. To do so, the compiler logic unit 180 is configured to analyze and determine one or more sections of a source code of an application that includes storage operations and computations on the storage data, and determine whether the one or more sections may be offloaded to corresponding data storage device 160 as offload kernels. Subsequently, the compiler logic unit 180 is further configured to compile those identified sections of the source code as offload functions and non-offload functions such that the compiled application can be executed on a compute device 102 regardless of a storage-offload capability of corresponding storage device 106. It should be appreciated that the compiler compute device 104 may include other or additional components, such as those commonly found in a computer (e.g., one or more processors, a memory, communication circuitry, a display, peripheral devices, etc.).

As shown in FIG. 1, the illustrative compute device 102 includes a compute engine (also referred to herein as “compute engine circuitry”) 120, an input/output (I/O) subsystem 130, communication circuitry 140, the compiler logic unit 150, and one or more data storage devices 160. It should be appreciated that, in other embodiments, the compute device 102 may include other or additional components, such as those commonly found in a computer (e.g., a display, peripheral devices, etc.). Additionally, in some embodiments, one or more of the illustrative components may be incorporated in, or otherwise form a portion of, another component. The compute engine 120 may be embodied as any type of device or collection of devices capable of performing various compute functions described below. In some embodiments, the compute engine 120 may be embodied as a single device such as an integrated circuit, an embedded system, a field-programmable gate array (FPGA), a system-on-a-chip (SOC), or other integrated system or device. In the illustrative embodiment, the compute engine 120 includes or is embodied as a processor 122 and a memory 124. The processor 122 may be embodied as any type of processor capable of performing the functions described herein. For example, the processor 122 may be embodied as a multi-core processor(s), a microcontroller, or other processor or processing/controlling circuit. In some embodiments, the processor 122 may be embodied as, include, or be coupled to an FPGA, an application specific integrated circuit (ASIC), reconfigurable hardware or hardware circuitry, or other specialized hardware to facilitate performance of the functions described herein.

The main memory 124 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the main memory 124 may be integrated into the processor 122. In operation, the main memory 124 may store various software and data used during operation such as applications, libraries, and drivers.

The compute engine 120 is communicatively coupled to other components of the compute device 102 via the I/O subsystem 130, which may be embodied as circuitry and/or components to facilitate input/output operations with the compute engine 120 (e.g., with the processor 122 and/or the main memory 124), one or more data storage devices 160, and other components of the compute device 102. For example, the I/0 subsystem 130 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 130 may form a portion of a system-on-a-chip (SoC) and be incorporated, along with one or more of the processor 122, the main memory 124, and other components of the compute device 102, into the compute engine 120.

The communication circuitry 140 may be embodied as any communication circuit, device, or collection thereof, capable of enabling communications over a network (not shown) between the compute device 102 and another compute or storage device. The communication circuitry 140 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 140 includes a network interface controller (NIC) 142, which may also be referred to as a host fabric interface (HFI). The NIC 142 may be embodied as one or more add-in-boards, daughter cards, network interface cards, controller chips, chipsets, or other devices that may be used by the compute device 102 to connect with another compute device. In some embodiments, the NIC 142 may be embodied as part of a system-on-a-chip (SoC) that includes one or more processors, or included on a multichip package that also contains one or more processors. In some embodiments, the NIC 142 may include a local processor (not shown) and/or a local memory (not shown) that are both local to the NIC 142. In such embodiments, the local processor of the NIC 142 may be capable of performing one or more of the functions of the compute engine 120 described herein. Additionally or alternatively, in such embodiments, the local memory of the NIC 142 may be integrated into one or more components of the compute device 102 at the board level, socket level, chip level, and/or other levels.

The compute device 102 may include one or more data storage devices 160a or be connected to one or more data storage devices 160b. In the illustrative embodiment, the data storage device 160 may be embodied as any type of device configured for short-term or long-term storage of data such as, for example, memory devices and circuits, memory cards, hard disk drives, solid-state drives, or other data storage device. The data storage device 160 may include a system partition that stores data and firmware code for the data storage device 160 and configuration data for features of the data storage device 160. The data storage device 160 may also include one or more operating system partitions that store data files and executables for operating systems. Additionally, in the illustrative embodiment, the data storage device 160 includes the performance logic unit 162.

In some embodiments, the compute device 102 may also include a runtime compiler logic unit 150, which may be embodied as software or circuitry (e.g., a co-processor, a microcontroller, an application specific integrated circuit (ASIC), a field programmable gate array (FPGA), etc.) configured to automatically deploying one or more sections of the source code of the application to associated data storage devices 160 at run-time. To do so, the compiler logic unit 150 is configured to analyze and determine one or more sections of a source code of an application that includes offload operations and determine whether the one or more sections may be offloaded to corresponding data storage device 160 as offload kernels.

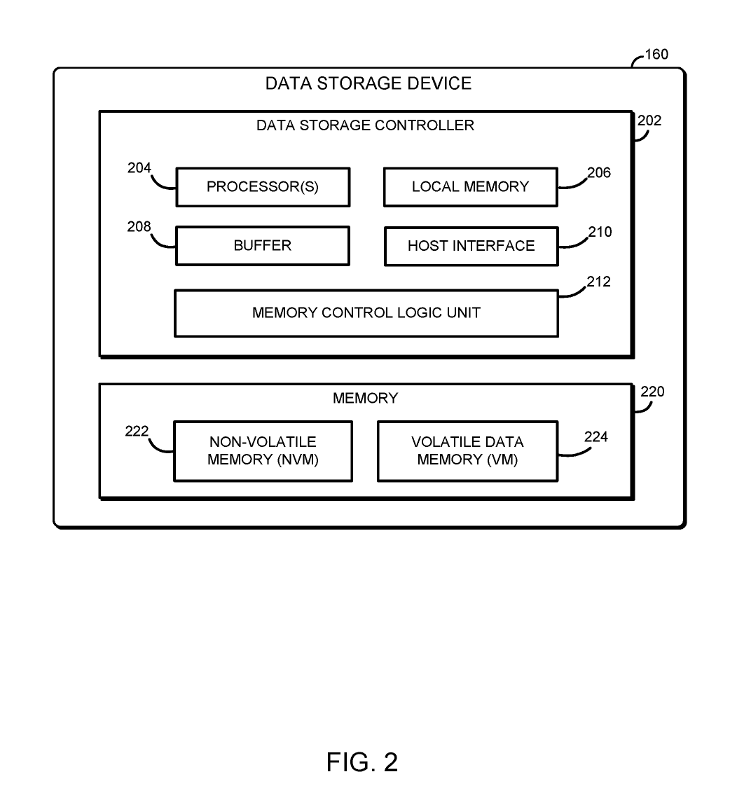

Referring now to FIG. 2, in the illustrative embodiment, the data storage device 160 includes the data storage controller 202 and a memory 220, which illustratively includes a non-volatile memory 222 and a volatile memory 224. The data storage controller 202 may be embodied as any type of control device, circuitry or collection of hardware devices capable of extending an offload application program interface (API) to execute one or more offload kernels inside the data storage device 160. The data storage controller 202 may execute an offload (a compiled section of the source code) and perform offload operations directly inside the data storage device 160, as described in more detail herein. In the illustrative embodiment, the data storage controller 202 includes a processor (or processing circuitry) 204, a local memory 206, a host interface logic unit 210, and a memory control logic unit 212. In some embodiments, the processor 204, memory control logic unit 212, and the memory 220 may be included in a single die or integrated circuit. It should be appreciated that the data storage controller 202 may include additional devices, circuits, and/or components commonly found in a controller of a data storage device in other embodiments.

The processor 204 may be embodied as any type of processor capable of performing the functions disclosed herein. For example, the processor 204 may be embodied as a single or multi-core processor(s), digital signal processor, microcontroller, FPGA, or other processor or processing/controlling circuit. Similarly, the local memory 206 may be embodied as any type of volatile and/or non-volatile memory or data storage capable of performing the functions disclosed herein. In the illustrative embodiment, the local memory 206 stores firmware and/or instructions executable by the processor 204 to perform the described functions of the data storage controller 202. In some embodiments, the processor 204 and the local memory 206 may form a portion of a System-on-a-Chip (SoC) and be incorporated, along with other components of the data storage controller 202, onto a single integrated circuit chip. As described above, the processor 204 is configured to execute non-offload functions of the compiled application.

The host interface 210 may also be embodied as any type of hardware processor, processing circuitry, input/output circuitry, and/or collection of components capable of facilitating communication of the data storage device 160 with a host device (e.g., the compute device 102) or service. That is, the host interface 210 embodies or establishes an interface for accessing data stored on the data storage device 160 (e.g., stored in the memory 220) and to communicate the offload operations and its results. To do so, the host interface 210 may be configured to use any suitable communication protocol and/or technology to facilitate communications with the data storage device 160 depending on the type of data storage device. For example, the host interface 210 may be configured to communicate with a host device or service using Serial Advanced Technology Attachment (SATA), Peripheral Component Interconnect express (PCIe), Serial Attached SCSI (SAS), Universal Serial Bus (USB), Non-Volatile Memory Express (NVMe), and/or other communication protocol and/or technology in some embodiments. These protocols may be extended to support offloading of operations, e.g., by also supporting OpenCL.

The buffer 208 may be embodied as volatile memory used by data storage controller 202 to temporarily store data that is being read from or written to the memory 220 during offload operations. The particular size of the buffer 208 may be dependent on the total storage size of the memory 220. The memory control logic unit 212 is illustratively embodied as hardware circuitry and/or devices (e.g., a processor, an ASIC, etc.) configured to control the read/write access to data at particular storage locations of the memory 220.

The non-volatile memory 222 may be embodied as any type of data storage capable of storing data in a persistent manner (even if power is interrupted to non-volatile memory 222). For example, in the illustrative embodiment, the non-volatile memory 222 is embodied as a set of multiple non-volatile memory devices. The non-volatile memory devices of the non-volatile memory 222 are illustratively embodied as NAND Flash memory devices. However, in other embodiments, the non-volatile memory 222 may be additionally or alternatively include any combination of memory devices that use chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM) or Spin Transfer Torque (STT)-MRAM. The volatile memory 224 may be embodied as any type of data storage device or devices capable of storing data while power is supplied to the volatile memory 224, similar to the memory 220 described with reference to FIG. 2. For example, in the illustrative embodiment, the volatile memory 224 is embodied as one or more dynamic random-access memory (DRAM) devices.

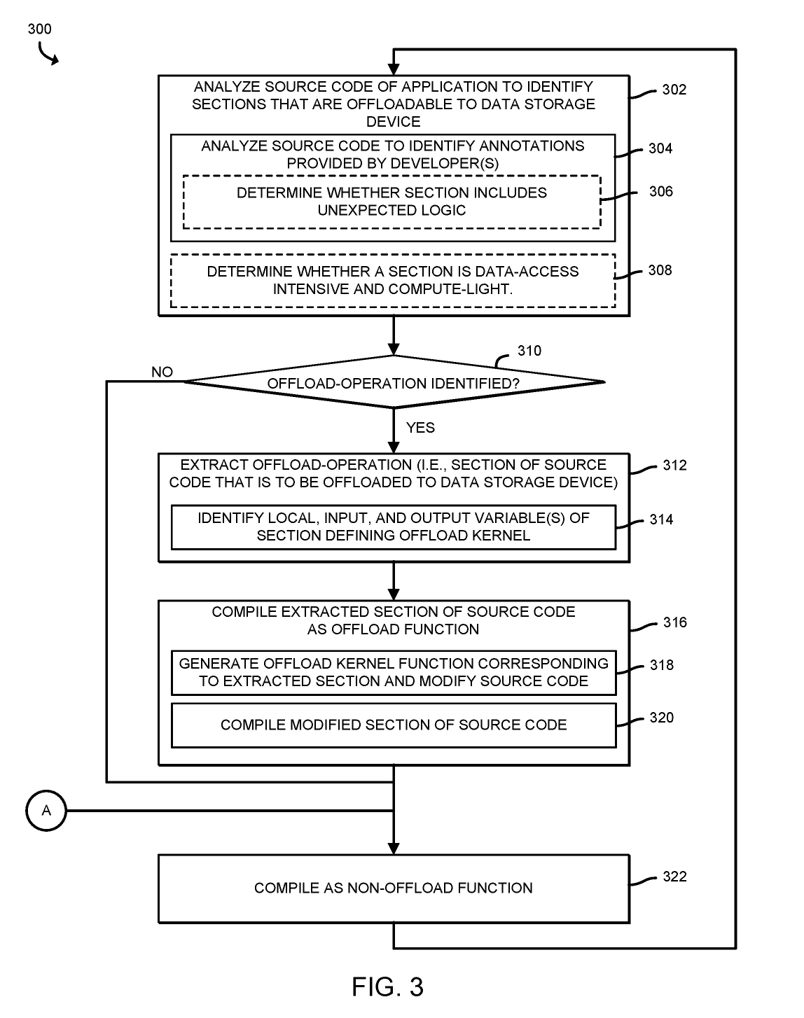

Referring now to FIG. 3, in use, the compiler compute device 104 may execute a method 300 at compile time for automatic compilation of offloading operations as offload functions that are to be executed on a data storage device 160. The method 300 begins with block 302, in which the compiler compute device 104 automatically analyzes the source code of the application to identify one or more sections of the source code that are offloadable to one or more data storage devices 160. To do so, the compiler compute device 104 analyzes the source code to identify annotations provided by a developer(s) of the source code as illustrated in block 304. In the illustrative embodiment, the developer may indicate start and stop of a section of the source code that includes offload-operations. For example, the developer may annotate start and stop of a section of the source code that is data-intensive but compute-light. As discussed above, such a section is a good candidate to be offloaded to the target data storage device 160 because it obviates a need for a large amount of data to be transferred back and forth between a processor of the compute device 102 and the data storage device 160 to do a small amount of work on each data element. However, it should be noted that the developer's annotations are not commands or directives but, rather, hints indicating that the section that may be offloaded to a target data storage device 160 as an offload kernel.

In some embodiments, the compiler compute device 104 may further determine whether the section defined by the start and stop annotations includes any unexpected logic as illustrated in block 306. For example, if the compiler compute device 104 is configured to process the section for an OpenCL-compatible data storage device, the unexpected logic is a portion of a source code that the OpenCL may not understand (e.g., network-socket calls, recursive calls, calls to functions in libraries whose source is not available, high-precision floating arithmetic, etc.). If the compiler compute device 104 determines that a section that is defined by the developer's start and stop annotations includes the unexpected logic, the compiler compute device 104 may ignore the developer's annotations and may not identify that section as a candidate that is to be offloaded to a data storage device 160 to prevent any execution error at the data storage device 160.

Additionally or alternatively, in block 308, the compiler compute device 104 may identify offload-operations based on a determination that the operations require many data accesses and few compute operations. For example, the compiler compute device 104 may determine whether a number of accesses or a number of compute operations is within a pre-set or user-specified threshold or ratio. Additionally or alternatively, in some embodiments, the compiler compute device 104 may identify a section of the source code that may be offloaded to the data storage device 160 by implementing machine-learning algorithms.

Subsequently, in block 310, the compiler compute device 104 determines whether an offload-operation (i.e., a section of the source code that may be offloaded to a data storage device 160) has been identified in the source code of the application. If the compiler compute device 104 determines that an offload-operation is not identified, the method 300 skips ahead to block 322 to compile the source code as non-offload functions. If, however, the compiler compute device 104 determines that an offload-operation has been identified, the method 300 advances to block 312.

In block 312, the compiler compute device 104 extracts the offload-operation. The compiler compute device 104 further identifies local, input, and output variables based on the identified section defining an offload kernel as illustrated in block 314. For example, variables defined within a section and in a scope of the section are marked as local variables of the kernel. Variables defined within the section but also available beyond the scope of the section are output variable parameters for the offload kernel. Additionally, variables defined outside of the section and are read or written in the section are marked as input variable parameters of the kernel. It should be appreciated that if there is a disk I/0 inside the section, the disk I/O is translated to block-level addresses of the data storage device (e.g., a logical block address, an offset within the logical block address, and a number of bytes of input data to be processed) via calls to a file-system. For example, the compute device 102 may insert logic to call the file-system at run-time to disclose a file map of the file-system and passes as an input parameter to the offload kernel as the block-level addresses of the data storage device 160. The block-level addresses are used by the offload kernel of the data storage device to perform the offload operations.

Subsequently, in block 316, the compiler compute device 104 compiles the extracted section of the source code as offload functions. To do so, the compiler compute device 104 generates an offload kernel function corresponding to the extracted section and modifies the section of the source code to add the offload kernel function as illustrated in block 318. An exemplary logic of the modified section may be:
if (storage-device-that-contains-input-data supports OpenCL) then
   call kernel function with identified input and output variables
else
   original source code for the section

The compiler compute device 104 compiles the modified section of the source code as offload functions that can be executed by a corresponding storage device 160 that has the storage-offload capability (e.g., OpenCL-capable or compatible) as illustrated in block 320. Additionally, the compiler compute device 104 also compiles the extracted section of the source code as non-offload functions for those data storage devices 160 that do not have the storage-offload capability. As described above, this allows the compiler compute device 104 to automatically compile the same source code of an application such that the compiled application can be executed by the compute device 102 with or without a data storage device 160 that has the storage-offload capability. The method 300 then loops back to block 302 to continue monitoring if another application is to be compiled.

It should be appreciated that a storage-offload process (i.e., blocks 302-322) may be executed in parallel for each section of the source code that is determined to be offloaded to its target data storage device 160.

The method 300 is described in the context of ahead-of-time compilation, however, in other embodiments, the compute device 102 may perform a similar method for just-in-time compilation (e.g., compiling source code during run time). In such embodiments, the compute device 102 may determine a target data storage device 160 that is configured to instantiate the offload kernel to compile the section of the source code to perform the offload operation. Subsequently, the compute device 102 may determine whether the target data storage device 160 has the storage-offload capability. For example, if the compute device 102 is configured to process the section for an OpenCL-compatible data storage device, the compute device 102 determines whether the target data storage device 160 is OpenCL-capable or compatible. If the compute device 102 determines that the target storage device 160 does not have the storage-offload capability, the identified section of the source code remains intact and the source code is compiled by the compiler logic unit 150 of the compute device 102. If, however, the compute device 102 determines that the target storage device 160 has the storage-offload capability, the offload-operation is performed on the target data storage device 160 by compiling the section of the source code by the processor(s) 204 of the data storage device 160.

### EXAMPLES

Illustrative examples of the technologies disclosed herein are provided below. An embodiment of the technologies may include any one or more, and any combination of, the examples described below.

Example 1 includes a compute device comprising a compiler logic unit to analyze a source code of an application; identify a section of the source code that includes operations to be offloaded to a data storage device on a target compute device; extract, in response to an identification of the section that includes operations to be offloaded, the section of the source code; and compile the section of the source code extracted as an offload function.

Example 2 includes the subject matter of Example 1, and wherein to identify the section of the source code comprises to identify a section of the source code that includes one or more annotations indicative of start and stop of offload operations.

Example 3 includes the subject matter of any of Examples 1 and 2, and wherein to identify the section of the source code comprises to identify whether the section includes an unexpected logic.

Example 4 includes the subject matter of any of Examples 1-3, and wherein the compiler logic unit is further to ignore, in response to an identification of the unexpected logic, the one or more annotations in the section of the source code.

Example 5 includes the subject matter of any of Examples 1-4, and wherein to identify the section of the source code comprises to determine whether input data of a section is not accessed in other sections of the source code.

Example 6 includes the subject matter of any of Examples 1-5, and wherein to extract the section of the source code comprises to identify one or more local variables, one or more input variables, and one or more output variables of the section.

Example 7 includes the subject matter of any of Examples 1-6, and wherein the compiler logic unit is further to translate a disk I/O inside the section to block-level addresses of the data storage device to be passed to the offload kernel as the one or more input or output variables.

Example 8 includes the subject matter of any of Examples 1-7, and wherein to compile the section of the source code comprises to modify the section of the source code and compile the modified section of the source code as an offload function.

Example 9 includes the subject matter of any of Examples 1-8, and wherein the compiler logic unit is further to compile the section of the source code as a native code, such that the application is executed on the target compute device without a storage-offload capability.

Example 10 includes one or more machine-readable storage media comprising a plurality of instructions stored thereon that, in response to being executed, cause a compute device to analyze a source code of an application; identify a section of the source code that includes operations to be offloaded to a data storage device on a target compute device; extract, in response to an identification of the section that includes operations to be offloaded, the section of the source code; and compile the section of the source code extracted as an offload function.

Example 11 includes the subject matter of Example 10, and wherein to identify the section of the source code comprises to identify a section of the source code that includes one or more annotations indicative of start and stop of offload operations.

Example 12 includes the subject matter of any of Examples 10 and 11, and wherein to identify the section of the source code comprises to identify whether the section includes an unexpected logic.

Example 13 includes the subject matter of any of Examples 10-12, and further including a plurality of instructions that in response to being executed cause the compute device to ignore, in response to an identification of the unexpected logic, the one or more annotations in the section of the source code.

Example 14 includes the subject matter of any of Examples 10-13, and wherein to identify the section of the source code comprises to determine whether input data of a section is not accessed in other sections of the source code.

Example 15 includes the subject matter of any of Examples 10-14, and wherein to extract the section of the source code comprises to identify one or more local variables, one or more input variables, and one or more output variables of the section.

Example 16 includes the subject matter of any of Examples 10-15, and further including a plurality of instructions that in response to being executed cause the compute device to translate a disk I/O inside the section to block-level addresses of the data storage device to be passed to the offload kernel as the one or more input or output variables.

Example 17 includes the subject matter of any of Examples 10-16, and wherein to compile the section of the source code comprises to modify the section of the source code and compile the modified section of the source code as an offload function.

Example 18 includes the subject matter of any of Examples 10-17, and further including a plurality of instructions that in response to being executed cause the compute device to compile the section of the source code as a native code, such that the application is executed on the target compute device without a storage-offload capability.

Example 19 includes a method comprising analyzing, by a compute device, a source code of an application; identifying, by the compute device, a section of the source code that includes operations to be offloaded to a data storage device on a target compute device; extracting, in response to an identification of the section that includes operations to be offloaded and by the compute device, the section of the source code; and compiling, by the compute device, the section of the source code extracted as an offload function.

Example 20 includes the subject matter of Example 19, and wherein identifying the section of the source code comprises identifying a section of the source code that includes one or more annotations indicative of start and stop of offload operations.

Example 21 includes the subject matter of any of Examples 19 and 20, and further including determining, by the compute device, whether the section includes an unexpected logic; and ignoring, in response to an identification of the unexpected logic and by the compute device, the one or more annotations in the section of the source code.

Example 22 includes the subject matter of any of Examples 19-21, and wherein identifying the section of the source code comprises determining whether input data of a section is not accessed in other sections of the source code.

Example 23 includes the subject matter of any of Examples 19-22, and wherein extracting the section of the source code comprises identifying one or more local variables, one or more input variables, and one or more output variables of the section.

Example 24 includes the subject matter of any of Examples 19-23, and wherein compiling the section of the source code comprises modifying the section of the source code and compile the modified section of the source code as an offload function.

Example 25 includes the subject matter of any of Examples 19-24, and further including compiling the section of the source code as a native code, such that the application is executed on the target compute device without a storage-offload capability.

1. A compute device comprising
a compiler logic unit to:
analyze a source code of an application;
identify a section of the source code that includes operations to be offloaded to a data storage device on a target compute device;
extract, in response to an identification of the section that includes operations to be offloaded, the section of the source code; and
compile the section of the source code extracted as an offload function.

2. The compute device of claim 1, wherein to identify the section of the source code comprises to identify a section of the source code that includes one or more annotations indicative of start and stop of offload operations.

3. The compute device of claim 1, wherein to identify the section of the source code comprises to identify whether the section includes an unexpected logic.

4. The compute device of claim 3, wherein the compiler logic unit is further to ignore, in response to an identification of the unexpected logic, the one or more annotations in the section of the source code.

5. The compute device of claim 1, wherein to identify the section of the source code comprises to determine whether input data of a section is not accessed in other sections of the source code.

6. The compute device of claim 1, wherein to extract the section of the source code comprises to identify one or more local variables, one or more input variables, and one or more output variables of the section.

7. The compute device of claim 6, wherein the compiler logic unit is further to translate a disk I/O inside the section to block-level addresses of the data storage device to be passed to the offload kernel as the one or more input or output variables.

8. The compute device of claim 1, wherein to compile the section of the source code comprises to modify the section of the source code and compile the modified section of the source code as an offload function.

9. The compute device of claim 1, wherein the compiler logic unit is further to compile the section of the source code as a native code, such that the application is executed on the target compute device without a storage-offload capability.

10. One or more machine-readable storage media comprising a plurality of instructions stored thereon that, in response to being executed, cause a compute device to:
analyze a source code of an application;
identify a section of the source code that includes operations to be offloaded to a data storage device on a target compute device;
extract, in response to an identification of the section that includes operations to be offloaded, the section of the source code; and
compile the section of the source code extracted as an offload function.

11. The one or more computer-readable storage media of claim 10, wherein to identify the section of the source code comprises to identify a section of the source code that includes one or more annotations indicative of start and stop of offload operations.

12. The one or more computer-readable storage media of claim 10, wherein to identify the section of the source code comprises to identify whether the section includes an unexpected logic.

13. The one or more computer-readable storage media of claim 12, further comprising a plurality of instructions that in response to being executed cause the compute device to ignore, in response to an identification of the unexpected logic, the one or more annotations in the section of the source code.

14. The one or more computer-readable storage media of claim 10, wherein to identify the section of the source code comprises to determine whether input data of a section is not accessed in other sections of the source code.

15. The one or more computer-readable storage media of claim 10, wherein to extract the section of the source code comprises to identify one or more local variables, one or more input variables, and one or more output variables of the section.

16. The one or more computer-readable storage media of claim 15, further comprising a plurality of instructions that in response to being executed cause the compute device to translate a disk I/O inside the section to block-level addresses of the data storage device to be passed to the offload kernel as the one or more input or output variables.

17. The one or more computer-readable storage media of claim 10, wherein to compile the section of the source code comprises to modify the section of the source code and compile the modified section of the source code as an offload function.

18. The one or more computer-readable storage media of claim 10, further comprising a plurality of instructions that in response to being executed cause the compute device to compile the section of the source code as a native code, such that the application is executed on the target compute device without a storage-offload capability.

19. A method comprising:
analyzing, by a compute device, a source code of an application;
identifying, by the compute device, a section of the source code that includes operations to be offloaded to a data storage device on a target compute device;
extracting, in response to an identification of the section that includes operations to be offloaded and by the compute device, the section of the source code; and
compiling, by the compute device, the section of the source code extracted as an offload function.

20. The method of claim 19, wherein identifying the section of the source code comprises identifying a section of the source code that includes one or more annotations indicative of start and stop of offload operations.

21. The method of claim 19 further comprising:
determining, by the compute device, whether the section includes an unexpected logic; and
ignoring, in response to an identification of the unexpected logic and by the compute device, the one or more annotations in the section of the source code.

22. The method of claim 19, wherein identifying the section of the source code comprises determining whether input data of a section is not accessed in other sections of the source code.

23. The method of claim 19, wherein extracting the section of the source code comprises identifying one or more local variables, one or more input variables, and one or more output variables of the section.

24. The method of claim 19, wherein compiling the section of the source code comprises modifying the section of the source code and compile the modified section of the source code as an offload function.

25. The method of claim 19 further comprising compiling the section of the source code as a native code, such that the application is executed on the target compute device without a storage-offload capability.
